(19) United States
(12) Patent Application Publication
(10) Pub. No.: US 2021/0051846 A1
(43) Pub. Date: Feb. 25, 2021

(54) Spraying Systems and Vehicles

(71) Applicant: Gary A. Vandenbark, Greenfield, IN (US)

(72) Inventor: Gary A. Vandenbark, Greenfield, IN (US)

(21) Appl. No.: 17/091,631

(22) Filed: Nov. 6, 2020

Related U.S. Application Data
(63) Continuation-in-part of application No. 16/773,352, filed on Jan. 27, 2020.
Application No. 16/773,352 is a continuation-in-part of application No. 16/274,833, filed on Feb. 13, 2019, now Pat. No. 10,869,423.
Application No. 16/274,833 is a continuation-in-part of application No. 16/274,833, filed on Feb. 13, 2019, now Pat. No. 10,869,423.
(60) Provisional application No. 62/713,457, filed on Aug. 1, 2018.
(60) Provisional application No. 62/630,139, filed on Feb. 13, 2018.
(60) Provisional application No. 62/713,457, filed on Aug. 1, 2018.
(60) Provisional application No. 62/630,139, filed on Feb. 13, 2018.

(51) Int. Cl. A01C 23/00; A01M 7/00; B05B 12/08; B05B 1/14; B05B 1/08

(52) U.S. Cl. CPC A01C 23/007; A01M 7/0089; B05B 1/08; B05B 1/14; B05B 12/087

(57) ABSTRACT

Provided is a vehicle-mountable agricultural fluid spraying system with a plurality of spray nozzles that can be individually turned on and off while maintaining substantially constant spray pressure and flow rate through those of the spray nozzles that are on, all without the need for any variation in speed of a pump, and without any communication with any pressure sensor or flow rate sensor. This is accomplished by providing a return fluid communication system having valves and other components that activate and open incrementally when the spray nozzles are incrementally turned off, such that the pressurized fluid in the system remains at substantially the same pressure as any or all of the spray nozzles are turned on and off, including at high frequency by pulse width modulation. Also provided are vehicles such as tractors and trailers with such spraying systems mounted thereto.

### CROSS-REFERENCE TO RELATED APPLICATIONS

The present application claims priority to, incorporates herein by reference, and is a continuation of, U.S. patent application Ser. No. 16/773,352 filed Jan. 27, 2020 by inventors Steven R. Booher, Gary A. Vandenbark, and Mike Hilligoss, and entitled Spraying Systems, Kits, Vehicles, and Methods of Use, which published as US-2020-0156100 A1 on May 21, 2020 (herein “the '352 Application”). The present application claims priority to, incorporates herein by reference, and is a continuation of, U.S. patent application Ser. No. 16/274,833 filed Feb. 13, 2019 by inventors Steven R. Booher, Gary A. Vandenbark, and Mike Hilligoss, and entitled Kits, Systems, and Methods for Sprayers, which published as US-2019-0246557-A1 on Aug. 15, 2019 (herein “the '833 Application”). The present application claims priority to and incorporates herein by reference, U.S. provisional patent application Ser. No. 62/630,139 filed Feb. 13, 2018 by inventors Steven R. Booher, Gary A. Vandenbark, and Mike Hilligoss, and entitled Kits, Systems, and Methods for Sprayers (herein “the '139 Application”), and U.S. provisional patent application Ser. No. 62/713,457 filed Aug. 1, 2018 by inventor Gary A. Vandenbark and entitled Sprayer Systems, Kits, and Methods of Use (herein “the '457 Application”).

### FEDERALLY SPONSORED RESEARCH OR DEVELOPMENT

None.

### TECHNICAL FIELD

The present disclosure relates generally to spraying, and in particular to agricultural spraying with vehicle-mountable spraying equipment, as well as kits, systems, and methods regarding same. Such agricultural spraying includes, for example but not by way of limitation, horticulture and ground maintenance spraying, whether by self-propelled sprayer vehicles or by sprayer vehicles such as trailers that are propelled by another vehicle.

### BACKGROUND

Sprayer vehicles, or vehicles with spraying equipment mounted to them, are known and the details of their typical components and functions are not repeated here, except where incorporated by reference. For example, U.S. Pat. No. 8,191,798 B2 issued to Hahn et al. on Jun. 5, 2012 and entitled Agricultural Field Sprayer and Process for its Operation (“Hahn et al.”) is incorporated herein by reference. Hahn et al. describes a typically complex agricultural field sprayer system and process for its operation, which includes an electrically driven pump (50) locatable directly under a sprayer fluid tank for conveying the fluid from the tank to a supply line. In Hahn et al. a return line (54) connects the pump (50) to the tank (22), and a sprayer line (32) connecting the pump (50) to an application assembly (20). The return line (54) and the sprayer line (32) in Hahn et al. include electrically operated control valves (68, 64). An electronic control system (56) modulates the motor (46) and the control valves (64, 68) as a function of processing different variables, including vehicle speed, and control signals from various pressure sensors and flow sensors (70, 72, 75) that measure pressure or flow rate in the sprayer line (32) and the return lines (40, 54), as described for instance in Hahn et al. at Column 6, line 58 through Column 9, line 17.

Thus, in prior art systems such as Hahn et al., when a subset of one or more of the spray nozzles are turned on or off, while the other spray nozzles remain on, the electronic control system (56) must collect data from the various pressure sensors and flow sensors (70, 72, 75) in the sprayer lines (32) and return lines (54), process that data, then send a control signal to the motor to change its rotational speed, and also send control signals to one or more control valves (66) to control the return of fluid to the tank, all so that the fluid being sprayed from the other spray nozzles continues to spray at the same pressure and flow rate as before the subset of spray nozzles was turned on or off, for instance as described in Hahn et al. at Column 9, lines 4 through 17. Accordingly, in prior art systems such as Hahn et al., a technologically complex and expensive system, with its inherent vulnerabilities, maintenance issues, and lag times, is necessary to attempt to maintain approximately constant flow rates and pressures from spraying nozzles as one or more of them are selectively turned on and off.

What is needed is a simpler, more robust, quicker-to-react, and less expensive multi-nozzle agricultural field and horticultural sprayer system that can selectively shut and open one or more of its spraying nozzles during use while substantially maintaining the preexisting fluid pressure and flow rate out of the spraying nozzles that remain open.

### SUMMARY

The present invention elegantly addresses all the above challenges and provides numerous additional benefits as will be appreciated by persons of skill in the art upon reviewing this disclosure. The present novel sprayer system uses an elegant mechanical structure that is inexpensive and robust, and which passively maintains continuous pressure and flow through a set of spraying nozzles even as any subset of those nozzles are turned on and off, all without the need for any interventions by, or communications with, any electronic control systems, algorithms, pressure sensors, flow rates sensors, or motor/pump speed variations.

For example, provided in various example embodiments is a vehicle-mountable agricultural fluid spraying system with a plurality of spray nozzles that can be individually turned on and off while maintaining substantially constant spray pressure and flow rate through those of the spray nozzles that are on, all without the need for any variation in speed of a pump, and without any communication with any pressure sensor or flow rate sensor. In various example embodiments the spraying system may comprise a plurality of independently-operable and electronically-controlled spray nozzles, each of the spray nozzles configured to be electronically turned on by a control circuit and spray the fluid into the atmosphere at a first predetermined spraying pressure and flow rate, and to be electronically turned off by the control circuit and not spray the fluid. In various example embodiments the spraying system may comprise a tank configured to hold the fluid at substantially atmospheric pressure. In various example embodiments the spraying system may comprise a pump configured to run at a first predetermined speed and pump the fluid under higher than atmospheric pressure from the tank through a pressurized fluid communication system to the spray nozzles. In various example embodiments the spraying system may comprise a return fluid communication system configured to route the fluid from the pressurized fluid communication system to the tank through a plurality of electronically-controlled valves that are each independently operable and in fluid communication with the pressurized fluid communication system, the valves equal in number to the spray nozzles. In various example embodiments each of the valves may be configured to be electrically opened by the control circuit when a corresponding one of the spray nozzles is electronically turned off, and further configured to be electrically shut by the control circuit when a corresponding one of the spray nozzles is electronically turned on. In various example embodiments the return fluid communication system may be configured to present the fluid passing there through with a pressure drop selected so that the first predetermined spraying pressure and flow rate is substantially maintained through the spray nozzles that are on, while other of the spray nozzles are turned on and off.

In various example embodiments the spraying system may comprise the return fluid communication system having a plurality of pressure drop structures equal in number of the spray nozzles, the return fluid communication system configured to route the fluid from each of the valves to the tank through a corresponding one of the pressure drop structures. In various example embodiments the spraying system may comprise one or more of the pressure drop structures having an orifice configured to restrict the flow of the fluid there through. In various example embodiments the spraying system may comprise one or more of the pressure drop structures having a nozzle structure configured to restrict the flow of the fluid there through.

In various example embodiments the spraying system may comprise the return fluid communication system having a plurality of bypass tube structures equal in number of the spray nozzles, the return fluid communication system configured to route the fluid from each of the valves to the tank through a corresponding one of the bypass tube structures. In various example embodiments the spraying system may comprise the return fluid communication system having a return system in fluid communication with the tank, the return fluid communication system configured to route the fluid from each of the bypass tube structures to the tank through the return system. In various example embodiments the spraying system may comprise the return system being configured to be at substantially atmospheric pressure during operation.

In various example embodiments the spraying system may comprise the plurality of spray nozzles being configured to be individually turned on and off multiple times per second while maintaining substantially constant spray pressure and flow rate through those of the spray nozzles that are on. In various example embodiments the spraying system may comprise the plurality of spray nozzles being configured to be individually turned on and off multiple times per second by pulse width modulation, and the electronically-controlled valves being configured to be individually turned off and on multiple times per second while corresponding ones of the plurality of spray nozzles are individually turned on and off, respectively. In various example embodiments the spraying system may comprise the plurality of spray nozzles and the electronically-controlled valves being configured to be turned on and off by pulse width modulation.

Additionally provided is a vehicle with a vehicle-mountable agricultural fluid spraying system as described herein mounted thereto. Such vehicles may include self-propelled vehicles such as tractors or the like, or pulled vehicles such as trailers, for instance, as shown and described in the various references incorporated herein.

Additional aspects, alternatives and variations as would be apparent to persons of skill in the art are also disclosed herein and are specifically contemplated as included as part of the invention. The invention is set forth only in the claims as allowed by the patent office in this or related applications, and the following summary descriptions of certain examples are not in any way to limit, define or otherwise establish the scope of legal protection.

### BRIEF DESCRIPTION OF THE DRAWINGS

Examples of the invention can be better understood with reference to the following figures. The components within the figures are not necessarily to scale, emphasis instead being placed on clearly illustrating example aspects of the invention. In the figures, like reference numerals designate corresponding parts throughout the different views. It will be understood that certain components and details may not appear in the figures to assist in more clearly describing the invention.

FIG. 1 is a schematic diagram of a spraying system comprising a tank, a pump, a plurality of spray nozzles, and a return fluid communication system comprising a plurality of electronically-controlled valves corresponding in number to the number of spray nozzles, according to one example embodiment, the spraying system depicted in an off condition.

FIG. 2 is a schematic diagram of the example spraying system of FIG. 1, depicted in an on condition with the pump and all nozzles on and spraying, and all electronically-controlled valves of the return fluid communication system turned off.

FIG. 3 is a schematic diagram of the example spraying system of FIG. 2, depicted with one nozzle turned off and not spraying, and one of the electronically-controlled valves of the return fluid communication system turned on and returning fluid to the tank.

FIG. 4 is a schematic diagram of the example spraying system of FIG. 2, depicted with two nozzles turned off and not spraying, and two of the electronically-controlled valves of the return fluid communication system turned on and returning fluid to the tank.

FIG. 5 is a schematic diagram of the example spraying system of FIG. 2, depicted with three nozzles turned off and not spraying, and three of the electronically-controlled valves of the return fluid communication system turned on and returning fluid to the tank.

FIG. 6 is a schematic diagram of the example spraying system of FIG. 2, depicted with four nozzles turned off and not spraying, and four of the electronically-controlled valves of the return fluid communication system turned on and returning fluid to the tank.

FIG. 7 is a schematic diagram of the example spraying system of FIG. 2, depicted with five nozzles turned off and not spraying, and five of the electronically-controlled valves of the return fluid communication system turned on and returning fluid to the tank.

FIG. 8 is a schematic diagram of the example spraying system of FIG. 2, depicted with six nozzles turned off and not spraying, and six of the electronically-controlled valves of the return fluid communication system turned on and returning fluid to the tank.

FIG. 9 is a schematic diagram of the example spraying system of FIG. 2, depicted with seven nozzles turned off and not spraying, and seven of the electronically-controlled valves of the return fluid communication system turned on and returning fluid to the tank.

FIG. 10 is a schematic diagram of the example spraying system of FIG. 2, depicted with eight nozzles turned off and not spraying, and eight of the electronically-controlled valves of the return fluid communication system turned on and returning fluid to the tank.

FIG. 11 is a schematic diagram of the example spraying system of FIG. 2, depicted with all nine nozzles turned off and not spraying, and all nine of the electronically-controlled valves of the return fluid communication system turned on and returning fluid to the tank.

The invention is not limited to what is shown in these example figures. The invention is broader than the examples shown in the figures and covers anything that falls within any of the claims.

### DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, process operations well known to persons of skill in the art have not been described in detail in order not to obscure unnecessarily the present invention. Various techniques and mechanisms of the present invention will sometimes be described in singular form for clarity. However, it should be noted that some embodiments include multiple iterations of a technique or multiple mechanisms unless noted otherwise. Similarly, various steps of the methods shown and described herein are not necessarily performed in the order indicated, or performed at all in certain embodiments. Accordingly, some implementations of the methods discussed herein may include more or fewer steps than those shown or described. Further, the techniques and mechanisms of the present invention will sometimes describe a connection, relationship or communication between two or more entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

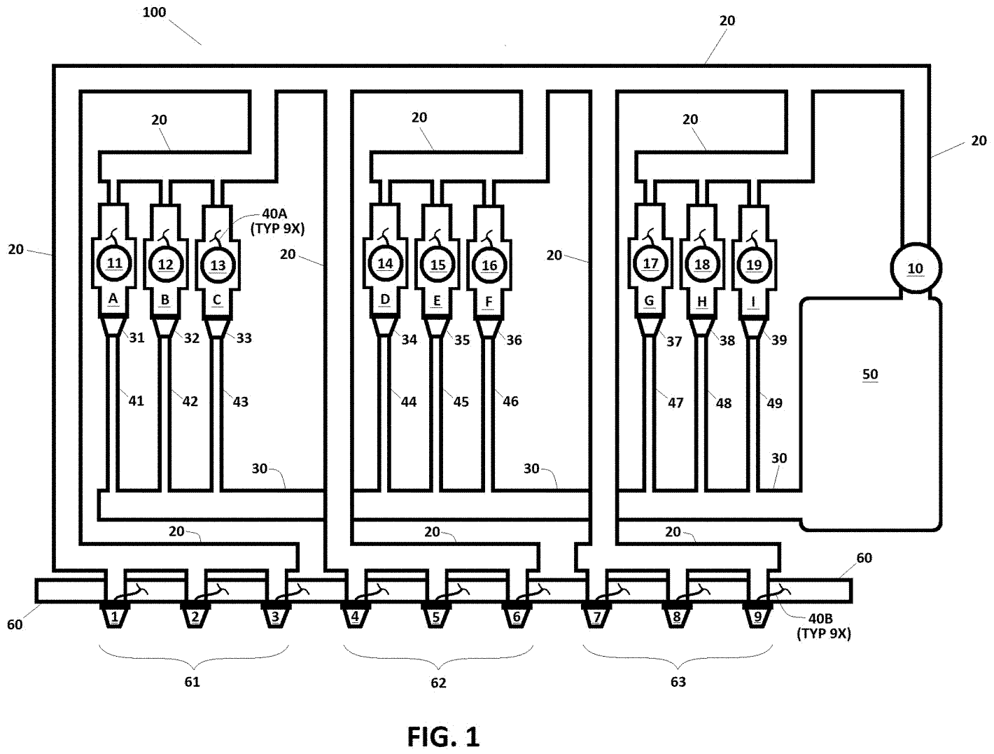

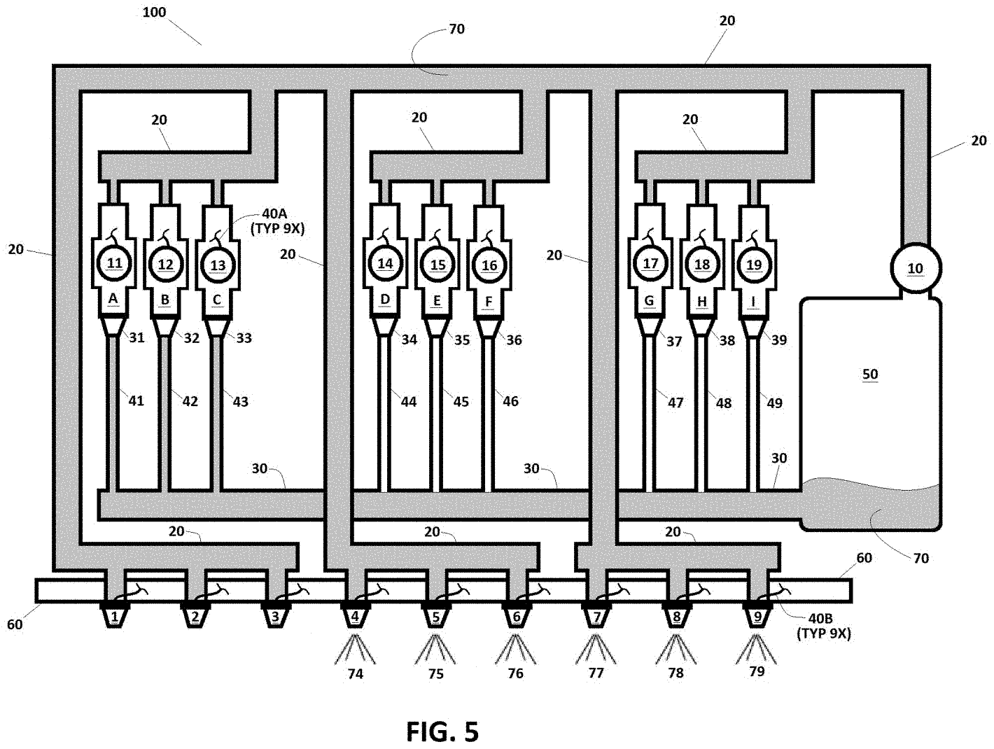

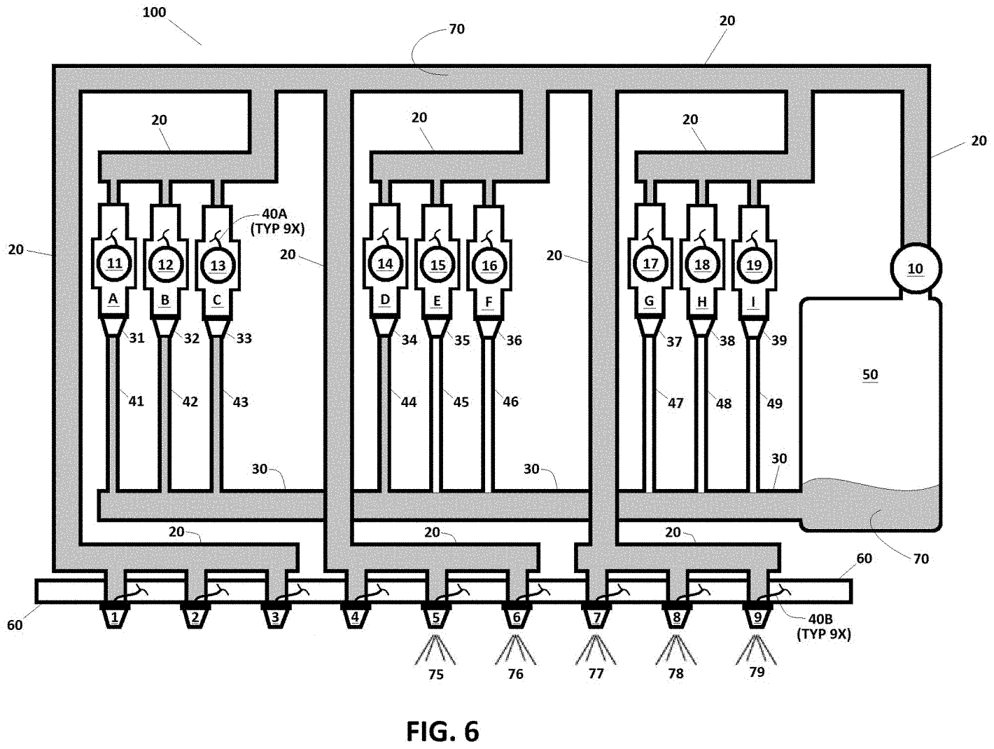

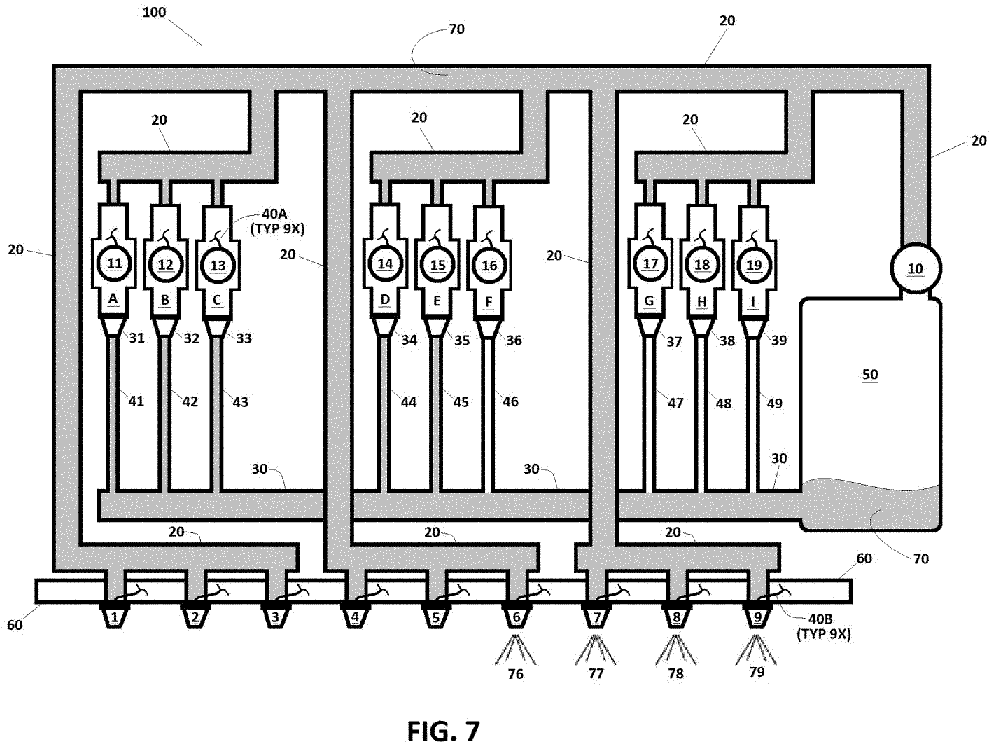

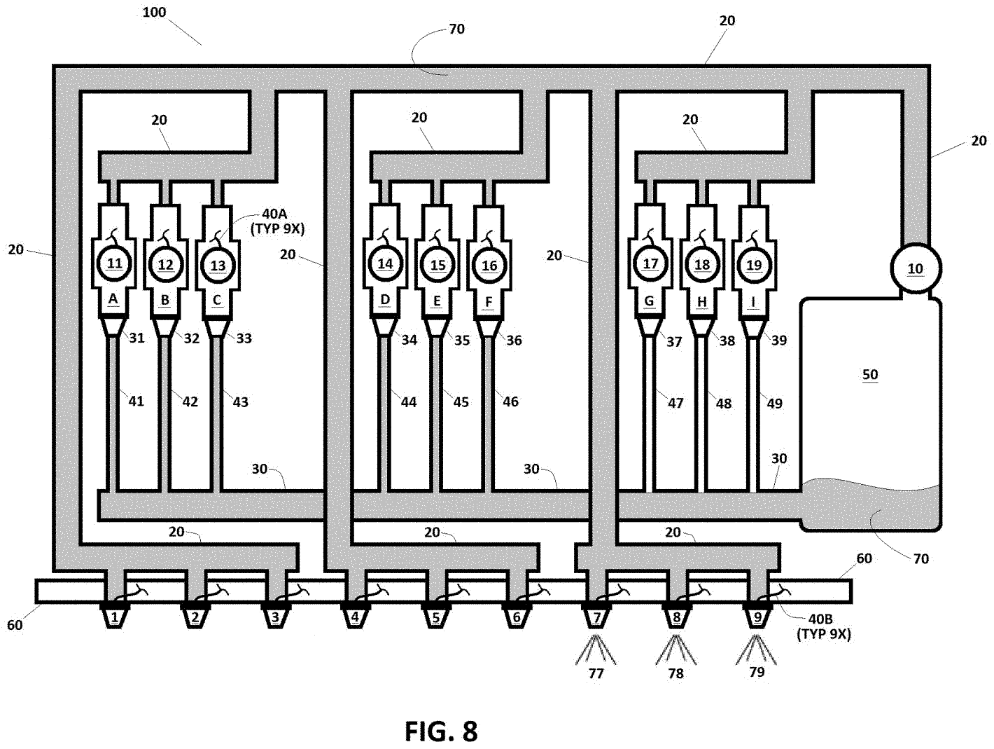

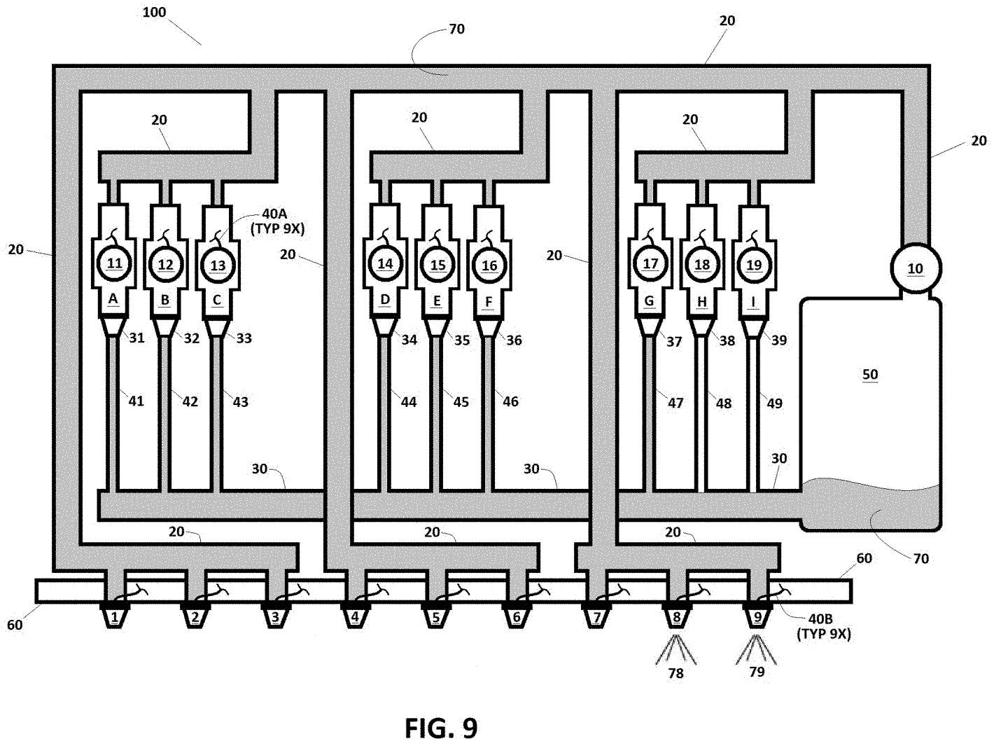

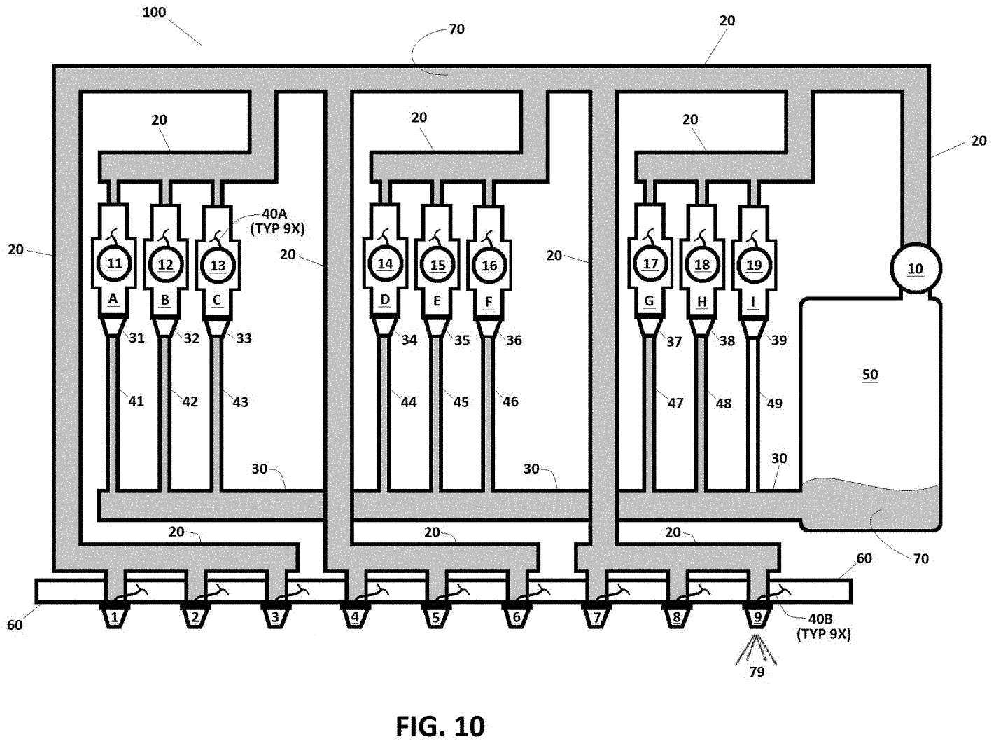

Turning to FIGS. 1-11, shown is an example vehicle-mountable spraying system 100 according to one example embodiment, comprising spray nozzles 1, 2, 3, 4, 5, 6, 7, 8, 9 shown attached to one or more booms 60 or similar structures, that can be individually turned on and off while maintaining substantially constant spray pressure and flow rate of fluid 70, such as an agricultural or horticultural fluid such as a fertilizer or herbicide or other type of fluid 70, through the spray nozzles 1 through 9 that are on (open), all without the need for any variation in speed of a pump 10, and without any communication with any pressure sensor or flow rate sensor (no sensors are shown because none are needed for the present feature, but sensors could be provided in various systems for other purposes).

In various example embodiments the spraying system 100 may comprise a plurality of independently-operable and electronically-controlled spray nozzles 1 through 9, each of the spray nozzles 1 through 9 electrically connected to a control circuit (not shown), for instance via wiring 40B (or wirelessly), and configured to be electronically turned on (opened) by the control circuit and spray the fluid 70 into the atmosphere at a first predetermined spraying pressure and flow rate, and to be electronically turned off (closed) by the control circuit and not spray the fluid 70. Any number of the spray nozzles 1 through 9 may be arranged on one or more booms 60 or similar structures into a left section 61, a center section 62, and a right section 63, for example, as shown in FIG. 1.

The spraying system 100 may further comprise one or more tank(s) 50 configured to hold the fluid 70 at substantially atmospheric pressure, and one or more pump(s) 10 configured to run at a first predetermined speed and pump the fluid 70 under higher than atmospheric pressure from the tank 50 through a pressurized fluid communication system 20, which may comprise any suitable plumbing structure of hoses, pipes, manifolds, and the like as is known in the art, to the spray nozzles 1 through 9.

The spraying system 100 may further comprise a return fluid communication system configured to route the fluid 70 from the pressurized fluid communication system 20 to the tank 50 through a plurality of electronically-controlled valves A, B, C, D, E, F, G, H, I that are each independently operable and in fluid communication with the pressurized fluid communication system 20 and with the tank 50, the valves A through I equal in number to the spray nozzles 1 through 9. In various example embodiments, each of the valves A through I may be configured to be electrically opened by the control circuit (not shown) when a corresponding one of the spray nozzles 1 through 9 is electronically turned off, and further configured to be electrically shut by the control circuit (not shown) when a corresponding one of the spray nozzles 1 through 9 is electronically turned on. In various example embodiments, each of the valves A through I may be electronically-controlled to open or shut by corresponding electrically-actuated mechanisms such as solenoids 11, 12, 13, 14, 15, 16, 17, 18, 19, each of which may be connected to the control circuit (not shown) by wires 40A.

In various example embodiments, the return fluid communication system may be configured to present the fluid 70 passing there through with a pressure drop selected so that the first predetermined spraying pressure and flow rate is substantially maintained through the spray nozzles 1 through 9 that are on, while other of the spray nozzles 1 through 9 are turned on and off. The selected pressure drop(s) in the return fluid communication system may be achieved in various example embodiments by configuring the spraying system 100 so that fluid 70 passing through selected ones of the valves A through I, when corresponding solenoids 11 through 19 are actuated to open selected ones of the valves A through I, is routed from the pressurized fluid communication system 20, through selected ones of the valves A through I, through corresponding pressure drop structures 31, 32, 33, 34, 35, 36, 37, 38, 39, each of which may comprise nozzles or other structures having specially sized orifices or other flow restrictions, through corresponding bypass tube structures 41, 42, 43, 44, 45, 46, 47, 48, 49, into a return system 30 that directs the fluid 70 back into the tank 50. The sizes, shapes, lengths, contours, and other geometries and surfaces of the components of the return fluid communication system (for instance valves A through I, pressure drop structures 31 through 39, bypass tube structures 41 through 49, and return system 30) may be selected, as known in the art of mechanical engineering fluid mechanics, so that fluid 70 passing from the pressurized fluid communication system 20 through any one of the open valves A through I of the return fluid communication system to the tank 50, is subjected to substantially the same pressure drop as fluid 70 passing from the pressurized fluid communication system 20 through any corresponding one of the open spray nozzles 1 through 9.

An example spraying system 100 will now be described in use. FIG. 1 depicts an example spraying system 100 in the off condition, neither pumping nor spraying any fluid 70. The example system 100 comprises a tank 50, a pump 10, a plurality of spray nozzles 1 through 9, and a return fluid communication system comprising a plurality of electronically-controlled valves A through I corresponding in number to the number of spray nozzles 1 through 9.

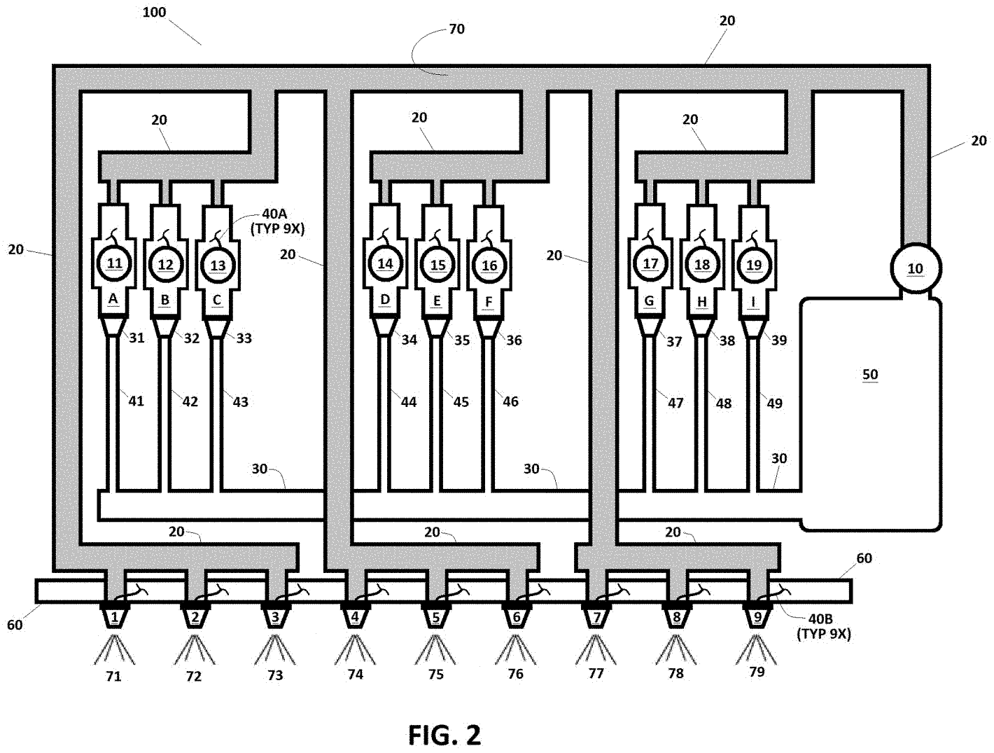

FIG. 2 depicts the example spraying system 100 in an on condition with the pump 10 on and pumping fluid 70 into the pressurized fluid communication system 20, while all spray nozzles 1 through 9 are on and open and spraying fluid 70 into the atmosphere as depicted by corresponding spray patterns 71, 72, 73, 74, 75, 76, 77, 78, 79, and while all electronically-controlled valves A through I of the return fluid communication system are turned off and closed by the control circuit (not shown).

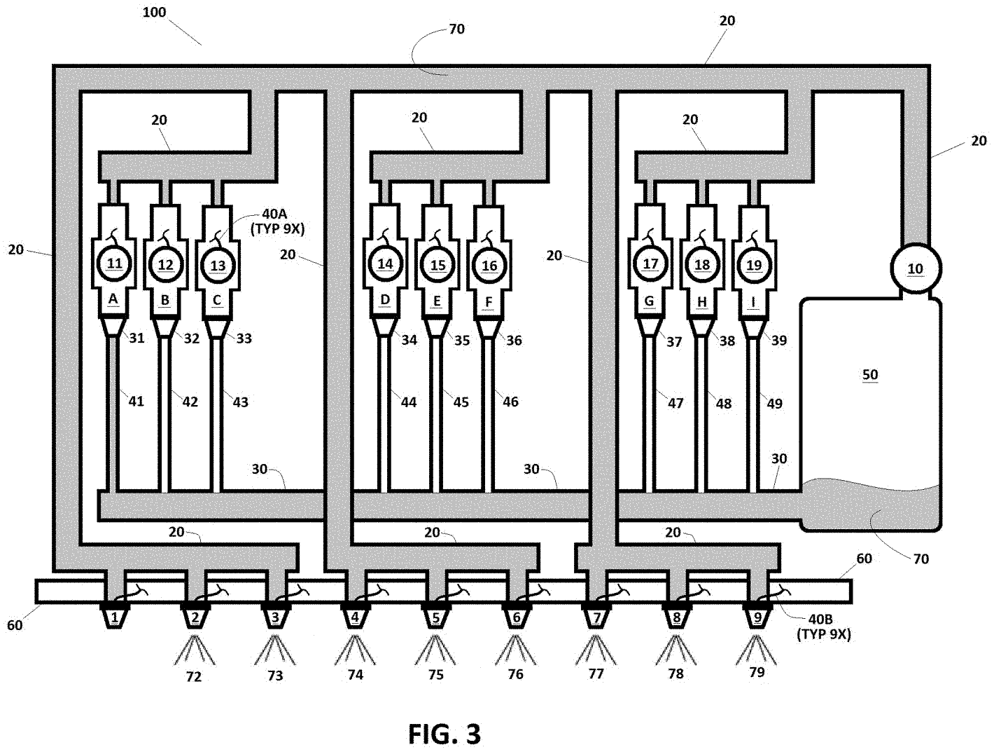

FIG. 3 depicts the example spraying system 100 in the on condition of FIG. 2, but with a first nozzle 1 turned off by the control system (connected to the nozzle 1 by wiring 40B, or wirelessly) and not spraying fluid 70, and the corresponding electronically-controlled valve A of the return fluid communication system turned on and opened by its electrically-actuated mechanism 11 (connected to the control circuit by wiring 40A, or wirelessly) and returning fluid 70 to the tank 50 by passing the fluid 70 from the pressurized fluid communication system 20, through the valve A, through pressure drop structures 31, through bypass tube structure 41, into return system 30 and to the tank 50, such that the spraying pressure and flow of fluid 70 through nozzles 2 through 9 is substantially maintained as before the nozzle 1 was turned off, all without the need for any variation in speed of the pump 10, and without any communication with any pressure sensor or flow rate sensor.

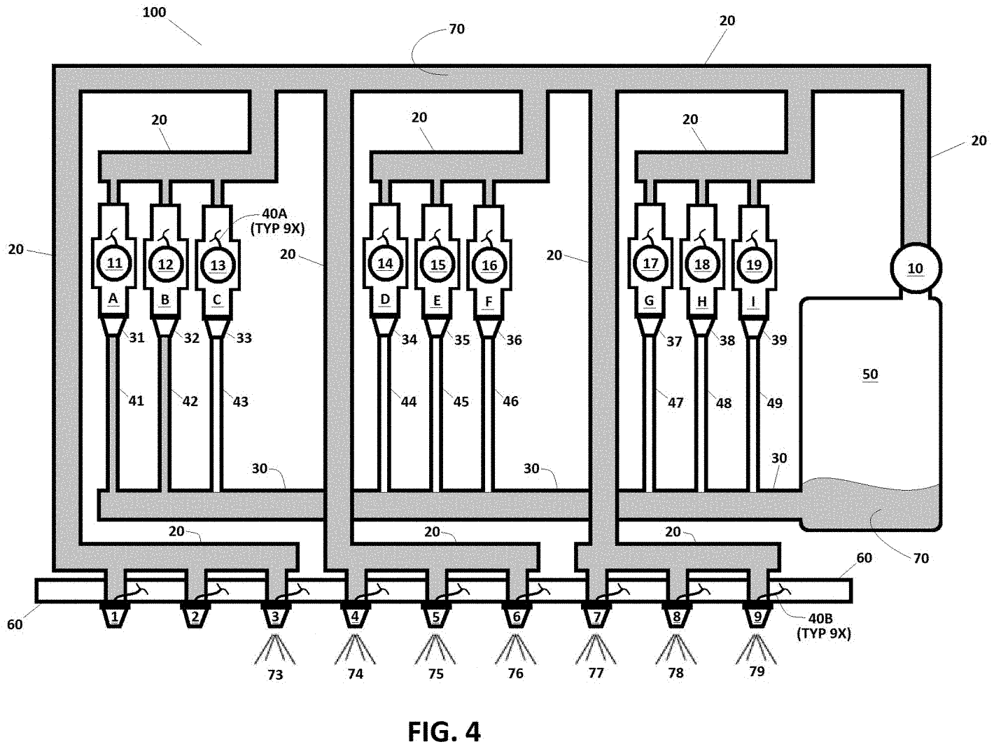

Likewise incrementally in FIGS. 4 through 10, the example spraying system 100 is depicted in the on condition of FIG. 2, but with additional nozzles (2 through 8) incrementally turned off by the control system (connected to the nozzles 2 through 8 by wiring 40B, or wirelessly) and not spraying fluid 70, while the corresponding electronically-controlled valves (B through H) of the return fluid communication system are incrementally turned on and opened by their corresponding electrically-actuated mechanisms 12 through 18 (connected to the control circuit by wiring 40A, or wirelessly) and returning fluid 70 to the tank 50 by passing the fluid 70 from the pressurized fluid communication system 20, incrementally through the valves B through H, incrementally through pressure drop structures 32 through 38, incrementally through bypass tube structures 42 through 48, into return system 30 and to the tank 50, such that the spraying pressure and flow of fluid 70 through the open ones of nozzles 3 through 9 is substantially maintained as the other ones of nozzles 2 through 8 are turned off and closed, all without the need for any variation in speed of the pump 10, and without any communication with any pressure sensor or flow rate sensor.

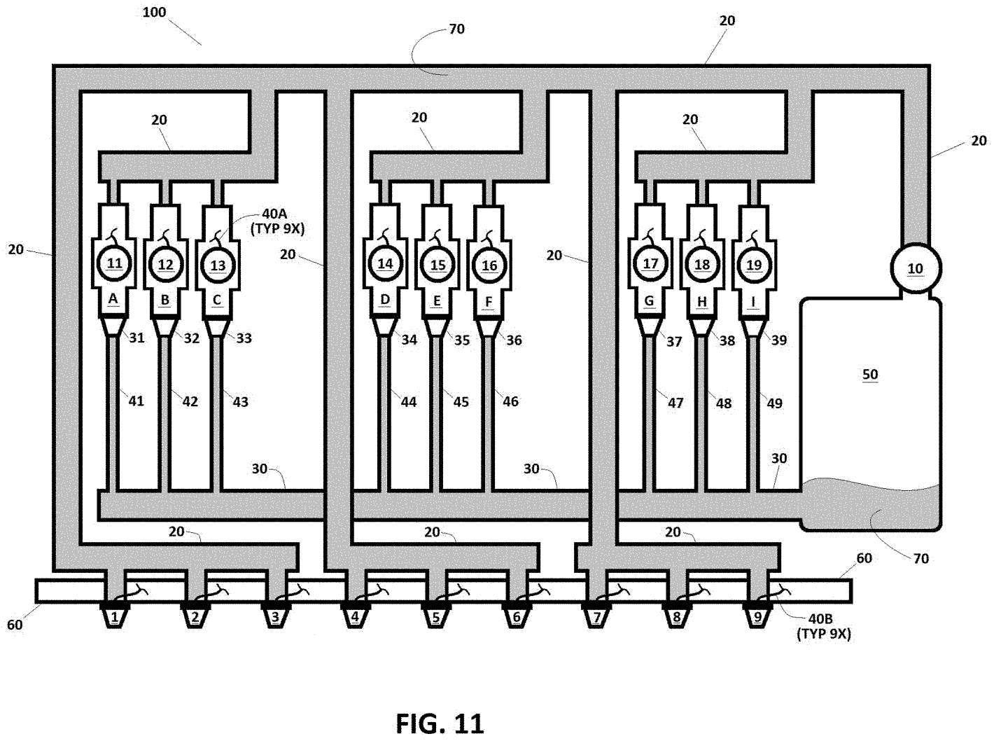

FIG. 11 depicts the example spraying system 100 in the on condition of FIG. 2, but with all the spray nozzles 1 through 9 turned off by the control system (connected to the spray nozzles 1 through 9 by wiring 40B, or wirelessly) and not spraying fluid 70, with the corresponding electronically-controlled valves A through I of the return fluid communication system turned on and opened by their electrically-actuated mechanisms 11 through 19 (connected to the control circuit by wiring 40A, or wirelessly) and returning fluid 70 to the tank 50 by passing the fluid 70 from the pressurized fluid communication system 20, through the valves A through I, through pressure drop structures 31 through 39, through bypass tube structures 41 through 49, into return system 30 and to the tank 50. In this state shown in FIG. 11 the system 100 is ready for the control system to instantaneously turn on and open any or all of the spray nozzles 1 through 9, while simultaneously closing corresponding ones of valves A through I, such that the spraying pressure and flow of fluid 70 through whichever of spray nozzles 1 through 9 that are turned on and opened will be substantially maintained as before the spray nozzles 1 through 9 were turned off and shut, all without the need for any variation in speed of the pump 10, and without any communication with any pressure sensor or flow rate sensor.

It is understood that while the present figures depict the incremental shutting off and closing of spray nozzles 1 through 9 in numerical order, the same result would be obtained with the present system if the spray nozzles 1 through 9 were shut off and closed in any order, or simultaneously in any groupings. It is likewise understood that the spraying pressure and flow of fluid 70 through any of spray nozzles 1 through 9 that are on and open will be substantially maintained as other of the spray nozzles 1 through 9 that were off and closed are turned back on and opened, because of the simultaneous shutting of corresponding valves A through I, all without the need for any variation in speed of the pump 10, and without any communication with any pressure sensor or flow rate sensor. In other words, the system 100 performs the same pressure and flow rate regulation of fluid through spray nozzles 1 through 9 as they are turned on and opened, as the system 100 does when spray nozzles 1 through 9 are turned off and shut, in any order.

It is further understood that while the system 100 is primarily described herein in the context where the speed of the pump 10 is held constant, the system 100 can perform the same pressure and flow-regulating aspects among the nozzles 1 through 9 as the pressure and flow rate of fluid 70 through the nozzles 1 through 9 is increased or decreased globally by adjusting the speed of the pump 10 (or by other means of increasing or decreasing the pressure of the fluid 70 in the pressurized fluid communication system 20). Changing the pressure and consequent flow rate of fluid 70 through the system 100 does not change the capability of the system 100 to regulate the performance of the nozzles 1 through 9 with respect to each other, for example by maintaining desired pressure and flow rate through nozzles 1 through 9 that are on and open while other of the nozzles 1 through 9 are turned on and off (opened and closed).

In various example embodiments the system 100 may utilize high-frequency actuatable pulse-width-modulated solenoids to actuate and turn on and off (open and close) both the spray nozzles 1 through 9 and corresponding valves A through I, such that the volume of fluid 70 sprayed out of any or all of the spray nozzles 1 through 9 can be selectably changed in real time by simultaneously adjusting the pulse width of the signals controlling any or all the spray nozzles 1 through 9 and the corresponding solenoids 11 through 19 on the valves A through I. In such example embodiments each spray nozzle 1 through 9 is momentarily turned on and off at high frequency (such as ten times per second, for example) by pulse width modulation, and the corresponding valves A through I of the return fluid communication system are simultaneously turned off and on, respectively, such that the spraying pressure and flow of fluid 70 through each of the spray nozzles 1 through 9 can be selectively controlled and varied, all without the need for any variation in speed of the pump 10, and without any communication with any pressure sensor or flow rate sensor. In other words, with the present system 100, the speed of activation and deactivation of any of nozzles 1 through 9 does not change performance of the ones of nozzles 1 through 9 that are on, open, and spraying fluid 70. This is in contrast to known systems, which require sophisticated sensing and other fluid management techniques to prevent pressure spikes, spray pattern irregularities, and droplet size changes, when modulating one or more spray nozzles using pulse width modulation.

As used herein, the terms “substantially constant,” “substantially maintained,” and the like, when used with respect to spray pressure and flow rate, mean sufficiently constant to not materially affect the spray pattern or droplet size of fluid 70 flowing out of the ones of nozzles 1 through 9 that are on and open.

In various example embodiments an existing spraying system comprising spray nozzle 1 through 9 can be retrofitted by to provide the functionalities of the present system 100, for instance by providing and installing thereon a kit comprising the components of the return fluid communication system, such as valves A through I, pressure drop structures 31 through 39, bypass tube structures 41 through 49, and return system 30, to achieve a system 100 as shown in FIG. 1, for example. Control circuity can also be provided or adapted within existing control circuity to cause the valves A through I to open when spray nozzles 1 through 9 are turned off and closed, and to cause the valves A through I to close when spray nozzle 1 through 9 are turned on and open.

While the example system 100 is described as having a certain number of spray nozzles 1 through 9, and a corresponding number of components in the return fluid communication system, such as valves A through I, pressure drop structures 31 through 39, bypass tube structures 41 through 49, it is understood that any suitable number of spray nozzles, and corresponding number of components in the return fluid communication system, may be used to achieve a system that functions according to the present invention.

Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

What is claimed is:

1. A vehicle-mountable agricultural fluid spraying system with a plurality of spray nozzles that can be individually turned on and off while maintaining substantially constant spray pressure and flow rate through those of the spray nozzles that are on, all without the need for any variation in speed of a pump, and without any communication with any pressure sensor or flow rate sensor, the spraying system comprising:
a plurality of independently-operable and electronically-controlled spray nozzles, each of the spray nozzles configured to be electronically turned on by a control circuit and spray the fluid into the atmosphere at a first predetermined spraying pressure and flow rate, and to be electronically turned off by the control circuit and not spray the fluid;
a tank configured to hold the fluid at substantially atmospheric pressure;
a pump configured to run at a first predetermined speed and pump the fluid under higher than atmospheric pressure from the tank through a pressurized fluid communication system to the spray nozzles;
a return fluid communication system configured to route the fluid from the pressurized fluid communication system to the tank through a plurality of electronically-controlled valves that are each independently operable and in fluid communication with the pressurized fluid communication system, the valves equal in number to the spray nozzles;
each of the valves configured to be electrically opened by the control circuit when a corresponding one of the spray nozzles is electronically turned off, and further configured to be electrically shut by the control circuit when a corresponding one of the spray nozzles is electronically turned on; and
the return fluid communication system configured to present the fluid passing there through with a pressure drop selected so that the first predetermined spraying pressure and flow rate is substantially maintained through the spray nozzles that are on, while other of the spray nozzles are turned on and off.

2. The vehicle-mountable agricultural fluid spraying system of claim 1, wherein the return fluid communication system further comprises a plurality of pressure drop structures equal in number of the spray nozzles, the return fluid communication system configured to route the fluid from each of the valves to the tank through a corresponding one of the pressure drop structures.

3. The vehicle-mountable agricultural fluid spraying system of claim 2, wherein one or more of the pressure drop structures comprises an orifice configured to restrict the flow of the fluid there through.

4. The vehicle-mountable agricultural fluid spraying system of claim 2, wherein one or more of the pressure drop structures comprises a nozzle structure configured to restrict the flow of the fluid there through.

5. The vehicle-mountable agricultural fluid spraying system of claim 1, wherein the return fluid communication system further comprises a plurality of bypass tube structures equal in number of the spray nozzles, the return fluid communication system configured to route the fluid from each of the valves to the tank through a corresponding one of the bypass tube structures.

6. The vehicle-mountable agricultural fluid spraying system of claim 5, wherein the return fluid communication system further comprises a return system in fluid communication with the tank, the return fluid communication system configured to route the fluid from each of the bypass tube structures to the tank through the return system.

7. The vehicle-mountable agricultural fluid spraying system of claim 5, wherein the return system is configured to be at substantially atmospheric pressure during operation.

8. The vehicle-mountable agricultural fluid spraying system of claim 1, wherein the plurality of spray nozzles are configured to be individually turned on and off multiple times per second while maintaining substantially constant spray pressure and flow rate through those of the spray nozzles that are on.

9. The vehicle-mountable agricultural fluid spraying system of claim 8, wherein the plurality of spray nozzles are configured to be individually turned on and off multiple times per second by pulse width modulation, and the electronically-controlled valves are configured to be individually turned off and on multiple times per second while corresponding ones of the plurality of spray nozzles are individually turned on and off, respectively.

10. The vehicle-mountable agricultural fluid spraying system of claim 9, wherein the plurality of spray nozzles and the electronically-controlled valves are configured to be turned on and off by pulse width modulation.

11. A vehicle comprising an agricultural fluid spraying system with a plurality of spray nozzles that can be individually turned on and off while maintaining substantially constant spray pressure and flow rate through those of the spray nozzles that are on, all without the need for any variation in speed of a pump, and without any communication with any pressure sensor or flow rate sensor, the spraying system comprising:
a plurality of independently-operable and electronically-controlled spray nozzles, each of the spray nozzles configured to be electronically turned on by a control circuit and spray the fluid into the atmosphere at a first predetermined spraying pressure and flow rate, and to be electronically turned off by the control circuit and not spray the fluid;
a tank configured to hold the fluid at substantially atmospheric pressure;
a pump configured to run at a first predetermined speed and pump the fluid under higher than atmospheric pressure from the tank through a pressurized fluid communication system to the spray nozzles;
a return fluid communication system configured to route the fluid from the pressurized fluid communication system to the tank through a plurality of electronically-controlled valves that are each independently operable and in fluid communication with the pressurized fluid communication system, the valves equal in number to the spray nozzles;
each of the valves configured to be electrically opened by the control circuit when a corresponding one of the spray nozzles is electronically turned off, and further configured to be electrically shut by the control circuit when a corresponding one of the spray nozzles is electronically turned on; and
the return fluid communication system configured to present the fluid passing there through with a pressure drop selected so that the first predetermined spraying pressure and flow rate is substantially maintained through the spray nozzles that are on, while other of the spray nozzles are turned on and off.

12. The vehicle of claim 11, wherein the return fluid communication system further comprises a plurality of pressure drop structures equal in number of the spray nozzles, the return fluid communication system configured to route the fluid from each of the valves to the tank through a corresponding one of the pressure drop structures.

13. The vehicle of claim 12, wherein one or more of the pressure drop structures comprises an orifice configured to restrict the flow of the fluid there through.

14. The vehicle of claim 12, wherein one or more of the pressure drop structures comprises a nozzle structure configured to restrict the flow of the fluid there through.

15. The vehicle of claim 11, wherein the return fluid communication system further comprises a plurality of bypass tube structures equal in number of the spray nozzles, the return fluid communication system configured to route the fluid from each of the valves to the tank through a corresponding one of the bypass tube structures.

16. The vehicle of claim 15, wherein the return fluid communication system further comprises a return system in fluid communication with the tank, the return fluid communication system configured to route the fluid from each of the bypass tube structures to the tank through the return system.

17. The vehicle of claim 15, wherein the return system is configured to be at substantially atmospheric pressure during operation.

18. The vehicle of claim 11, wherein the plurality of spray nozzles are configured to be individually turned on and off multiple times per second while maintaining substantially constant spray pressure and flow rate through those of the spray nozzles that are on.

19. The vehicle of claim 18, wherein the plurality of spray nozzles are configured to be individually turned on and off multiple times per second by pulse width modulation, and the electronically-controlled valves are configured to be individually turned off and on multiple times per second while corresponding ones of the plurality of spray nozzles are individually turned on and off, respectively.

20. The vehicle of claim 19, wherein the plurality of spray nozzles and the electronically-controlled valves are configured to be turned on and off by pulse width modulation.
